(19) United States
(12) Patent Application Publication
(10) Pub. No.: US 2008/0155467 A1
(43) Pub. Date: Jun. 26, 2008

(54) CONTENT SELECTABLE REPRODUCTION SYSTEM, METHOD THEREOF, AND PORTABLE REPRODUCTION UNIT CONTROL APPARATUS

(75) Inventors: Tomohiro OBITA, Kanagawa (JP); Shigeru Saegusa, Tokyo (JP); Sayoko Kanno, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/944,528

(22) Filed: Nov. 23, 2007

(30) Foreign Application Priority Data
Dec. 25, 2006 (JP) 2006-347782

(51) Int. Cl. G06F 3/048

(52) U.S. Cl. 715/810

(57) ABSTRACT

A content selectable reproduction system is disclosed. A content reproduction unit having a display function of a built-in or external display device includes a content reproduction section which reproduces content, an operation section which issues an operation command, and a first control section which inputs the operation command and controls the content reproduction section according to the operation command. A portable reproduction unit control apparatus connected to the content reproduction unit through a first connection section includes a display control section and a second control section which exchanges control signals with the first control section through the first connection section. A portable reproduction unit connected to the portable reproduction unit control apparatus through a second connection section includes a storage medium storing content data files and content management data with which the content data files are managed, a reproduction section reproducing the reproduction content files, and an operation section.

### CROSS REFERENCES TO RELATED APPLICATIONS

The present invention contains subject matter related to Japanese Patent Application JP 2006-347782 filed in the Japanese Patent Office on Dec. 25, 2006, the entire contents of which being incorporated herein by reference.

### BACKGROUND OF THE INVENTION

1. Field of the Invention

The present invention relates to a content selectable reproduction system, a method thereof, and a portable reproduction unit control apparatus that allow, for example, a stationary type audio reproduction unit to reproduce audio data recorded in a record medium disposed in a digital audio player.

2. Description of the Related Art

Recently, digital audio players (DAPs) have been widely used. A digital audio player is small and portable and is composed of a record medium that stores compressed song files, a file system that manages a plurality of song files, a decoder that reproduces a song file, an amplifier, an operation section, a built-in battery, a liquid crystal panel, and so forth. When song files recorded in such a digital audio player can be reproduced by a home-use stationary audio system, the song files stored in the digital audio player can be reproduced through speakers instead of a head set.

For example, an attachment section having a connector can be disposed in the stationary type audio reproduction unit and the digital audio player can be attached to the stationary type audio reproduction unit through the attachment section. By connecting the stationary type audio reproduction unit and the digital audio player through a predetermined interface, the stationary type audio reproduction unit can reproduce song files stored in the audio player.

Japanese Patent Application Laid-Open No. 2001-298676 (hereinafter referred to as patent document 1) describes an apparatus that operates a DVD (Digital Versatile Disc) reproduction unit that is mutually connected to a digital television receiver through the IEEE (Institute of Electrical and Electronics Engineers) 1394 standard using a remote control commander of the digital television receiver instead of separately operating the DVD reproduction unit and the digital television receiver.

Generally, the operation control for a stationary type audio reproduction unit is different from that for a digital audio player. To prevent the user from performing bothersome operations for these units with respective remote control commanders, it is preferred that they be able to be operated only with one remote control commander for the stationary type audio reproduction unit. When the stationary type audio reproduction unit side operates the digital audio player, the stationary type audio reproduction unit issues a command to control the digital audio player. The command is transferred to the digital audio player. In patent document 1, the digital television receiver side translates commands of the remote control commander into those for the DVD reproduction unit and transfers the resultant commands to the DVD reproduction unit.

### SUMMARY OF THE INVENTION

In the method of which the stationary type audio reproduction unit side issues commands to operate the digital audio player, because there are a plurality of types of digital audio players and control commands differ in individual models of the digital audio players, a heavy burden would be imposed on hardware and/or software that convert commands of the remote control commander for the stationary type audio reproduction unit into those for the digital audio player. In addition, since the development and modification cycles of digital audio players are fast, it would be difficult to issue commands for digital audio players that have been developed and modified.

In addition, since the shapes of the digital audio players are different and the shapes, dimensions, and so forth of their connectors are also different, it would be difficult to provide one universal type connection section suitable for many models of digital audio players.

In addition, since such a digital audio player has stored a large amount of audio data, when the user desires to reproduce his or her favorite song, he or she normally causes the digital audio player to display the titles of stored songs on its display section and selects his or her favorite song file from those that the digital audio player displays on its display section. Since the display section of the digital audio player has a small screen because of the size reduction of the digital audio player, the screen of the display section is not highly visible. If the screen of the television receiver can display a list of songs stored in the digital audio player, the user can easily select his or her favorite song.

Patent document 1 describes that a DVD operation OSD (On Screen Display) stored in a ROM of the DVD reproduction unit is displayed on the screen of the digital television receiver. However, the digital audio player displays a song title and so forth on a small liquid crystal panel. In other words, the digital audio player does not have a function of displaying song titles and so forth on a large screen of the display section of the television receiver unlike the DVD reproduction unit. Thus, it is difficult to display song titles and so forth of an output of the digital audio player on a large screen.

In view of the foregoing, it would be desirable to provide an adaptor type portable reproduction unit control apparatus applicable for each model of portable reproduction units. In addition, it would be desirable to provide a content selectable reproduction system, a method thereof, and a portable reproduction unit control apparatus that are capable of solving the foregoing problem in such a manner that the portable reproduction unit control apparatus has a function of generating a selectable content list signal and a function of issuing commands according to the portable reproduction units.

According to an embodiment of the present invention, there is provided a content selectable reproduction system composed of a content reproduction unit having a display function of a built-in or external display device, a portable reproduction unit control apparatus connected to the content reproduction unit through a first connection section, and a portable reproduction unit connected to the portable reproduction unit control apparatus through a second connection section. The content reproduction unit includes a content reproduction section which reproduces content, an operation section which issues an operation command, and a first control section which inputs the operation command and controls the content reproduction section according to the operation command. The portable reproduction unit control apparatus includes a display control section and a second control section which exchanges control signals with the first control section through the first connection section. The portable reproduction unit includes a storage medium which stores content data files and content management data with which the content data files are managed, a reproduction section which reproduces the reproduction content files, and an operation section. The second control section of the portable reproduction unit control apparatus reads the content management data from the storage medium of the portable reproduction unit through the second connection section, supplies the content management data to the display control section, causes the display control section to generate a selectable content list signal according to the content management data, and supplies the selectable content list signal to the content reproduction section of the content reproduction unit through the first connection section. The first control section of the content reproduction unit supplies the selectable content list signal to the display device, and causes the display device to display a selectable content list according to the selectable content list signal. The content to be reproduced is selected by a selection operation of the operation section according to the selectable content list and a selection operation signal of the operation section is supplied to the first control section. The first control section supplies the selection operation signal to the second control section through the first connection section. The portable reproduction unit is caused to reproduce content according to the selection operation signal received by the second control section and the reproduction signal is supplied to the content reproduction section of the content reproduction unit through the first connection section.

According to an embodiment of the present invention, there is provided a content selectable reproduction method for a content selectable reproduction system composed of a content reproduction unit having a display function of a built-in or external display device, a portable reproduction unit control apparatus connected to the content reproduction unit through a first connection section, and a portable reproduction unit connected to the portable reproduction unit control apparatus through a second connection section, the content reproduction unit having a content reproduction section which reproduces content, an operation section which issues an operation command, and a first control section which inputs the operation command and controls the content reproduction section according to the operation command, the portable reproduction unit control apparatus having a display control section, and a second control section which exchanges control signals with the first control section through the first connection section, the portable reproduction unit having a storage medium which stores content data files and content management data with which the content data files are managed, a reproduction section which reproduces the reproduction content files, and an operation section. The second control section of the portable reproduction unit control apparatus is caused to read the content management data from the storage medium of the portable reproduction unit through the second connection section. The second control section is caused to supply the content management data to the display control section. The display control section is caused to generate a selectable content list signal according to the content management data. The second control section is caused to supply the selectable content list signal to the content reproduction section of the content reproduction unit through the first connection section. The first control section of the content reproduction unit is caused to supply the selectable content list signal to the display device. The display device is caused to display a selectable content list according to the selectable content list signal. Content to be reproduced is caused to be selected by a selection operation of the operation section according to the selectable content list. A selection operation signal of the operation section is caused to be supplied to the first control section. The first control section is caused to supply the selection operation signal to the second control section through the first connection section. The portable reproduction unit is caused to reproduce content according to the selection operation signal received by the second control section. The reproduction signal is caused to be supplied to the content reproduction section of the content reproduction unit through the first connection section.

According to an embodiment of the present invention, there is provided a portable reproduction unit control apparatus. The portable reproduction unit control apparatus includes a first connection section connected to a content reproduction unit having a display function of a built-in or external display device, a second connection section connected to a portable reproduction unit, a display control section, and a second control section which exchanges control signals with a first control section of the content reproduction unit through the first connection section. The second control section reads the content management data from the storage medium of the portable reproduction unit through the second connection section, supplies the content management data to the display control section, causes the display control section to generate a selectable content list signal according to the content management data, and outputs the selectable content list signal to the content reproduction unit through the first connection section. The second control section receives a selection operation signal from the first control section of the content reproduction unit through the first connection section. The portable reproduction unit is caused to reproduce content according to the received selectable operation signal and the reproduction signal is output to the content reproduction unit through the first connection section.

According to an embodiment of the present invention, the portable reproduction unit control apparatus corresponds to each model of portable reproduction units. Since the portable reproduction unit control apparatus has a dedicated connection section, a problem of which the portable reproduction unit is not able to be connected to the content reproduction unit does not occur. Content management data are read from the portable reproduction unit. The display control section generates a selectable content list signal with the content management data that have been read. The selectable content list signal is supplied to the content reproduction unit. The built-in display device or an external display device of the content reproduction unit displays a selectable content list. The user can select his or her desired content, for example a song, only with the remote control commander or the like on the content reproduction unit side. Thus, the operability of the control of the portable reproduction unit and the content reproduction unit becomes high. In addition, the user can select content on a large screen. Thus, the operability of the portable reproduction unit and the content reproduction unit can be improved.

A selection operation signal generated by an operation on the content reproduction unit side is supplied to the portable reproduction unit control apparatus. The selection operation signal is converted into a command for the portable reproduction unit. As a result, selected content can be reproduced by the portable reproduction unit. The reproduced content is transferred to the content reproduction unit and reproduced thereby. The content is output, for example, from speakers. Since the portable reproduction unit control apparatus issues a command, the burden of issuing commands according to various models of portable reproduction units is not imposed on the content reproduction unit side.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a block diagram showing an outlined structure of a content selectable reproduction system according to an embodiment of the present invention;

FIG. 2 is a block diagram showing a content selectable reproduction system according to an embodiment of the present invention;

FIG. 3A and FIG. 3B are schematic diagrams exemplifying content management data of a content selectable reproduction system according to an embodiment of the present invention;

FIG. 4 is a schematic diagram exemplifying a selectable content indication of a content selectable reproduction system according to an embodiment of the present invention; and

FIG. 5 is a flow chart describing a flow of an operation of a content selectable reproduction system according to an embodiment of the present invention.

### DETAILED DESCRIPTION OF THE PREFERRED EMBODIMENTS

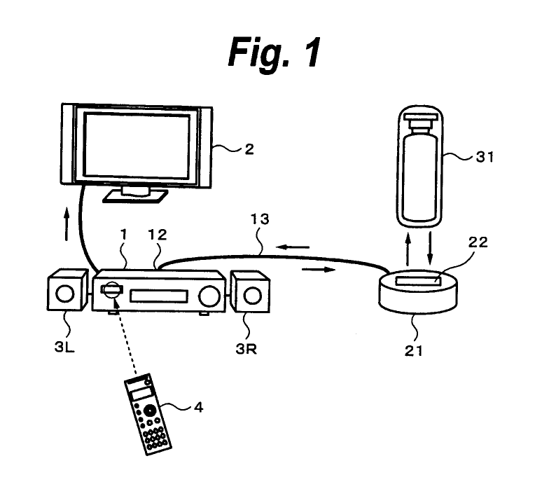

Next, embodiments of the present invention will be described. FIG. 1 shows an outlined structure of a content selectable reproduction system according to an embodiment of the present invention. Connected to an AV unit 1 that is a content reproduction unit are a display device 2 and 2-channel speakers 3L and 3R. The AV unit 1 can be operated by push buttons disposed on a front panel thereof and a remote control commander 4. In embodiments of the present invention, content means a creation such as audio information and video information provided through a medium or a network.

The AV unit 1 is for example an AV amplifier. The AV unit 1 switchably supplies externally input video signals and audio signals to the display device 2 and the speakers 3L and 3R. The AV unit 1 may be an AV amplifier having a disc reproduction function. In this case, the AV amplifier has a reproduction function, for example, for a CD, a DVD, a CD-R (Recordable), a CD-RW (ReWritable), and/or a next generation BD (Blu ray Disc).

Disposed on the rear (or front) of the AV unit 1 is a port 12. A connector connected to one end of a cable 13 is attached to the port 12. Connected to the other end of the cable 13 is an adaptor 21 that is a content reproduction unit control apparatus. The port 12 and the cable 13 correspond to first connection means of claims that follow. Specific examples of the first connection section include an interface based on a maker's unique standard, a USB (Universal Serial Bus) interface, and an IEEE (Institute of Electrical and Electronics Engineers) 1394 interface. The first connection section may be a wireless interface besides a wired interface. Examples of wireless interfaces include a Bluetooth (registered trademark) interface, a wireless LAN (Local Area Network) interface, and a UWB (Ultra Wide Band) interface.

An adaptor 21 has a table for a portable reproduction unit 31, for example, a digital audio player. The adaptor 21 has an attachment section 22 composed of a concave portion into which one end of the portable reproduction unit 31 can be inserted and mechanical contacts connected to those of the portable reproduction unit 31. The attachment section 22 corresponds to second connection means of claims that follow. Like the foregoing first connection means, a wireless or wired interface can be applied as the second connection means.

The portable reproduction unit 31 is composed of a flash memory (memory card or built-in flash memory) that stores digital audio data, a medium (record medium) such as a hard disk, a file system that manages a plurality of files, a decoding section that decodes a file that has been compression-encoded, an audio amplifier, a display control circuit, a display device, an operation section such as operation buttons, a battery as a power supply, and so forth. The portable reproduction unit may be applied, for example, to a mobile phone and so forth as a portable music reproduction unit besides a digital audio player. Besides a portable music reproduction unit, a portable music/video reproduction unit having a video reproduction display control circuit and a display device may be used.

Video data are compression-encoded according to the MPEG2 (Moving Picture Experts Group Phase 2) standard, the MPEG4 standard, the H.264/AVC (Advanced Video Coding) standard, the DivX standard, or the like. Audio data are compression-encoded according to the MP3 (MPEG1 Audio Layer 3) standard, the AAC (Advanced Audio Coding) standard, the ATRAC (Adaptive Transfer Acoustic Coding) standard, the WMA standard (Windows (registered trademark) Media Audio), or the like.

The interface is a wireless interface or a wired interface. Examples of wireless interfaces include a USB (Universal Serial Bus) interface, and an IEEE (Institute of Electrical and Electronics Engineers) 1394 interface. Examples of wired interfaces include a Bluetooth (registered trademark) interface, a wireless LAN (Local Area Network) interface, and a UWB (Ultra Wide Band) interface. Content data are transferred (streamed) and content management data are transferred through the interface.

In the content selectable reproduction system according to an embodiment of the present invention, when the portable reproduction unit 31 is attached to the attachment section 22 of the adaptor 21, a file system (hereinafter referred to as the content management data) that manages files, for example song files, stored in the medium of the portable reproduction unit 31 is read by the adaptor 21. An OSD (On Screen Display) controller as a display control section of the adaptor 21 generates a video signal that causes the display device to display attributes such as song titles contained in the content management data or play lists. This video signal is supplied to the AV unit 1 and displayed on the display device 2.

According to this embodiment, a GUI (Graphic User Interface) using a selectable content list is structured. With reference to the selectable content list on the display device 2, the user selects a song to be reproduced from the selectable content list with a remote control commander 4. The resultant selection operation signal is transferred to the adaptor 21. The adaptor 21 controls the portable reproduction unit 31 to retrieve a reproduction signal of the selected song. The AV unit 1 reproduces the reproduction signal through the speakers 3L and 3R. Audio content can be reproduced in a sequential reproduction mode of which songs are reproduced in the order of content management data and a shuffle reproduction mode of which songs are reproduced at random. In addition, audio content can be reproduced in a genre specific reproduction mode, an artist specific reproduction mode, and an album specific reproduction mode. In other words, when the user selects a reproduction mode, the AV unit 1 automatically reproduces a selected song (songs) according to the selected reproduction mode. The user can control operations, such as a reproduction operation, of the AV unit 1 with the remote control commander 4.

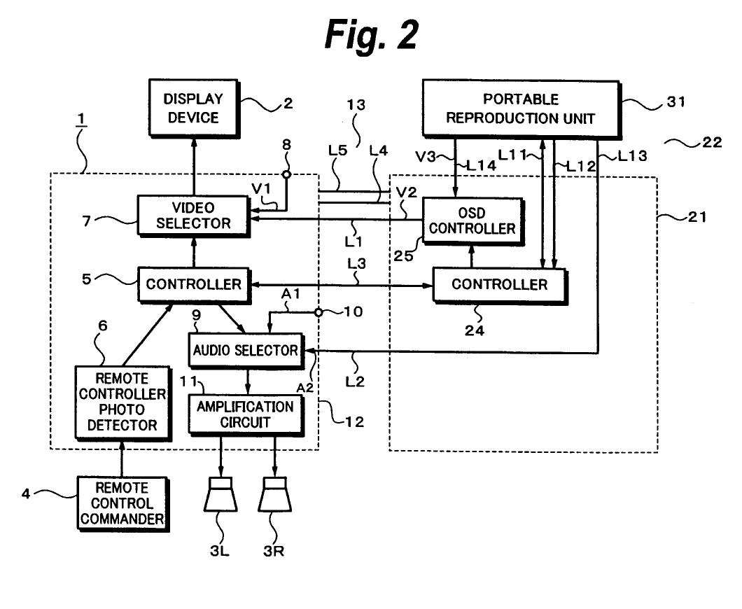

Next, with reference to FIG. 2, an embodiment of the present invention will be more specifically described. The AV unit 1 has a controller 5. The controller 5 is composed of a microcomputer that includes a CPU (Central Processing Unit), a ROM (Read Only Memory), and a RAM (Random Access Memory). The ROM has stored a program executed on the CPU and data necessary to execute the program. The RAM is used as a work memory of the CPU. When necessary, the CPU reads the program and data stored in the ROM and uses the RAM as the work memory to control each section of the AV unit 1.

A remote control signal is supplied from a remote controller photo detector 6 to the controller 5. The remote control signal is generated when the user operates the remote control commander 4. The controller 5 controls a video selector 7 and an audio selector 9. A video signal selected by the video selector 7 is supplied to the display device 2. The display device 2 displays the video signal on its screen. An audio signal selected by the audio selector 9 is supplied to the speakers 3L and 3R through an amplification circuit 11. The speakers 3L and 3R output the audio signal. The AV unit 1 has an electronic audio volume controller and so forth (not shown).

The adaptor 21 has a controller 24 that corresponds to a second control section of claims that follow and an OSD controller 25 that corresponds to a display control section of claims that follow. Like the controller 5, the controller 24 is composed of a microcomputer that includes a CPU. The OSD controller 25 generates a selectable content list signal of a text and so forth according to content management data. In addition, the adaptor 21 includes a charge control section (not shown) that charges a battery of the portable reproduction unit 31.

The cable 13 that extends from the connector connected to the port 12 of the AV unit 1 is a bundle of lines L1, L2, L3, L4, and L5. An OSD video signal V2 generated by the OSD controller 25 is supplied to the video selector 7 of the AV unit 1 through line L1. Video signal V1 is supplied from an input video terminal 8 to the video selector 7. One of video signal V1 and OSD video signal V2 is selected by the video selector 7 and the selected signal is supplied to the display device 2.

Analog audio signal V2 reproduced by the portable reproduction unit 31 is supplied to the audio selector 9 through line L2. Audio signal A1 is supplied from an input audio terminal 10 to the audio selector 9. One of audio signal A1 and reproduction audio signal A2 is selected by the audio selector 9 and the selected signal is supplied to the speakers 3L and 3R through the amplification circuit 11.

Line L3 is used to exchange (communicate) control signals between the controller 5 and the controller 24. The controller 5 and the controller 24 each have a UART (Universal Asynchronous Receiver Transmitter) that is a communication circuit used in a serial port of a personal computer. Lines L4 and L5 are a power supply voltage line and a ground voltage line, respectively. The adaptor 21 receives a power from the AV unit 1.

The portable reproduction unit 31 is attached to the attachment section 22 of the adaptor 21. The attachment section 22 has mechanical contacts for lines L11, L12, L13, and L14. The attachment section 22 corresponds to second connection means of claims that follow. As described above, like the first connection means of claims that follow, the attachment section 22 may be a wired interface or a wireless interface instead of mechanical contacts.

Line L11 is used to transfer control signals between the controller 24 and the portable reproduction unit 31. Line L12 is used to transfer content data that have been read from the portable reproduction unit 31 to the controller 24. Lines L11 and L12 may be a single line. Line L13 is used to output reproduction audio signal (analog) A2 from the portable reproduction unit 31. Reproduction audio signal A2 is supplied to the audio selector 9 of the AV unit 1 through line L2 of the cable 13.

Line L14 is used to output reproduction video signal (analog) V3 from the portable reproduction unit 31. Reproduction video signal V3 is supplied to the OSD controller 25. The OSD controller 25 superimposes reproduction video signal V3 with the selectable content list. When the portable reproduction unit 31 reproduces only an audio signal, the portable reproduction unit 31 does not output video signal V3. In this case, the selectable content list is displayed on a monochrome background.

The medium disposed in the portable reproduction unit 31 has stored audio content data and content management data with which the audio content data are managed. In embodiments of the present invention, “audio” means “audio and/or video”. Examples of content management data with which song files are managed include dedicated content management data, FAT (File Allocation Table) 16, FAT 32, and so forth that are used in personal computers. When dedicated content management data are used, files can be transferred only by dedicated transfer software. In contrast, when general purpose content management data are used, files can be transferred by a general purpose file management tool such as Explorer (registered trademark). In addition, content management data contain play list files created by the portable reproduction unit 31. The portable reproduction unit 31 according to this embodiment uses unique content management data.

The adaptor 21 is dedicated for the portable reproduction unit 31. The controller 24 can transmit a command to the portable reproduction unit 31 to read content management data from the portable reproduction unit 31 through line L12. The obtained content management data are stored in the RAM of the controller 24. The controller 24 has a function of interpreting movie titles associated with content, song information such as song titles, artist information such as artist names, and attribute data such as genres and play lists according to the obtained content management data.

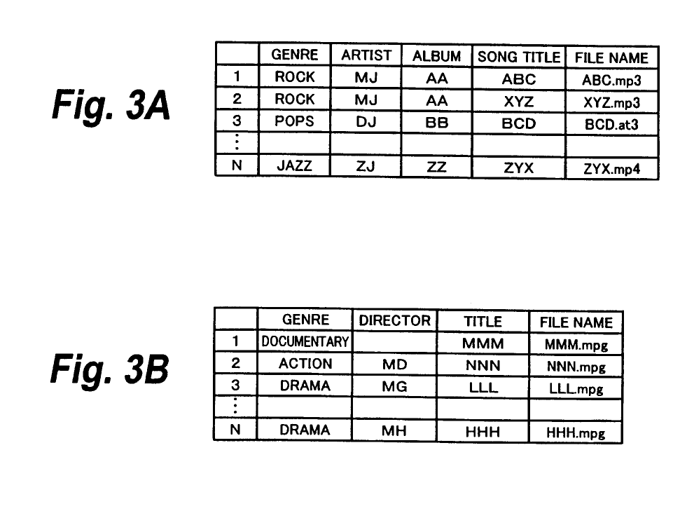

FIG. 3A and FIG. 3B exemplify content management data of the portable reproduction unit 31. FIG. 3A exemplifies music content management data. FIG. 3B exemplifies video content management data. In the music content management data, “genre”, “artist name”, “album title”, “song title”, and “file name” are correlated as attribute information for every N songs (files). In the video content management data, “genre”, “director name”, “title”, and “file name” are correlated as attribute information for every N record programs (files). The extension of a file name represents a compression-encoding method for the song (file). For example, extension “mpg” indicates that the file has been compression-encoded according to the MPEG4 standard. In the portable reproduction unit 31, files as pieces of content (not shown) are correlated with record positions on the medium.

For example, when content ID is “1”, attribute information is “rock”, “MJ”, “AA”, “ABC”, or “ABC.mp3”. These alphabetic characters are just examples, not specific, except for the extension of a file name. The extension of a file name represents a compression-encoding method of the song (file). In the foregoing example, the extension of the file indicates that the file has been compression-encoded according to the MP3 standard. Extension “at3” represents ATRAC3. “mp4” represents MPEG4. In the case of a play list, a play list file is composed of a plurality of pieces of content.

The portable reproduction unit 31 is connected to the adaptor 21. When the controller 24 of the adaptor 21 recognizes the connected portable reproduction unit 31, content management data are read to the RAM of the controller 24. The controller 24 interprets content ID and attribute information of content management data that have been read from the portable reproduction unit 31 and supplies text information necessary for generating a selectable content list signal to the OSD controller 25. The OSD controller 25 generates selectable content list signal V2.

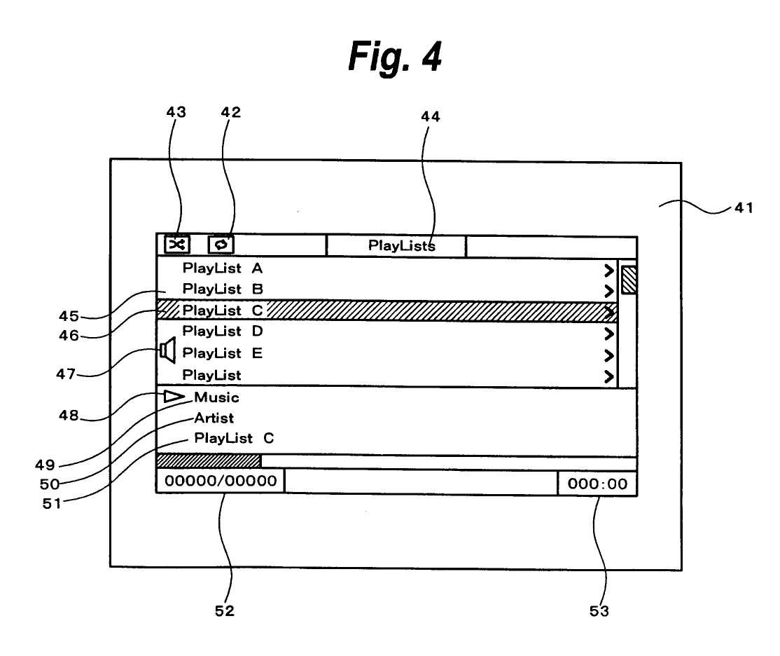

FIG. 4 exemplifies a selectable content list 41 displayed on the display device 2 and generated with selectable content list signal V2 supplied through the video selector 7. The selectable content list 41 contains as selectable items a shuffle icon 42 that indicates whether or not the shuffle reproduction mode has been set and a repeat icon 43 that indicates whether or not the repeat reproduction mode has been set. In the selectable content list 41, a menu title 44 indicates for example “PlayLists”.

The selectable content list 41 indicates a plurality of play lists with texts. In the selectable content list 41, a scroll bar 46 is positioned at one of the play lists. With up and down keys of direction keys of the remote control commander 4, the scroll bar 46 is scrolled up and down, respectively. In the selectable content list 41, a current reproduction icon 47 is indicated across the play list that is currently being reproduced.

In the selectable content list 41, a play state icon 48 indicates a track name 49, an artist name 50, and an album title 51 about a song that is being reproduced. In addition, the selectable content list 41 contains a song reproduction number/total song number 52 and an elapsed time 53. The selectable content list 41 shown in FIG. 4 is exemplary. Other lists can be displayed according to the menu.

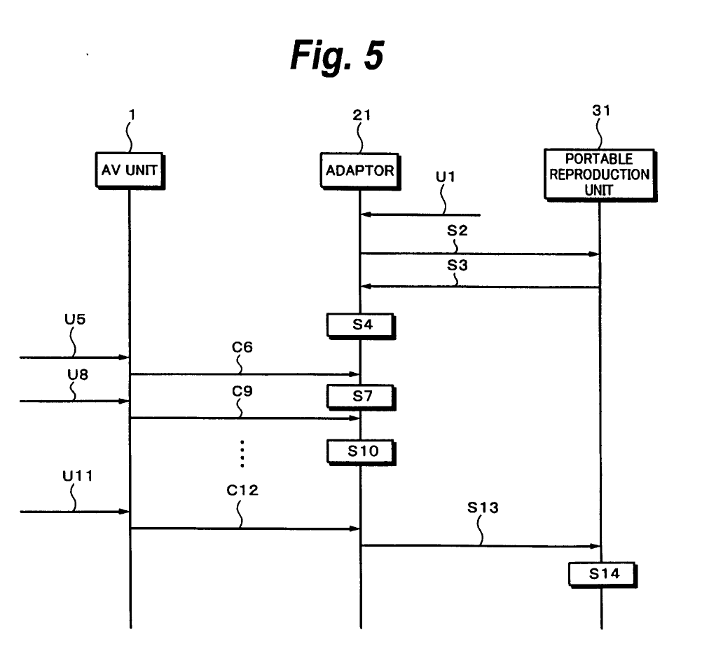

Next, with reference to FIG. 5, an operation of the foregoing embodiment of the present invention will be described. By pressing a button of the remote control commander 4 or an operation button of the main body of the AV unit 1, the controller 5 turns on the power of the AV unit 1 and causes the video selector 7 and the audio selector 9 to select a video signal and an audio signal from those of the adaptor 21. In addition, the controller 24 of the adaptor 21 is informed that a video signal and an audio signal have been selected from those of the adaptor 21 and they are ready to be output.

When the user attaches the portable reproduction unit 31 to the adaptor 21 (at step U1), the controller 24 of the adaptor 21 issues a request for content management data to the portable reproduction unit 31 (at step S2). The portable reproduction unit 31 outputs content management data to the controller 24 according to the request (at step S3). When the controller 24 has received the content management data, the controller 24 interprets them and supplies data necessary for the selectable content list to the OSD controller 25. The OSD controller 25 generates a selectable content list signal. The selectable content list signal is supplied to the AV unit 1. The display device 2 displays the selectable content list (at step S4).

With reference to the selectable content list, for example, play lists (see FIG. 4), the user operates the remote control commander 4 to select a song to which he or she desires to listen. An operation of which the user selects a song to which he or she desires to listen through a hierarchy is performed by user's cursor button operations (up and down keys of the directional keys) (at step U5), cursor command C6, list selection item change process by moving the scroll bar (at step S7), user's cursor button operation (at step U8), cursor command C9, list selection item change process (at step S10), and so forth.

While the scroll bar is positioned at a song to which the user desires to listen, he or she operates an enter button (at step U11). When the adaptor 21 has received enter command C12, the adaptor 21 issues a reproduction request for the song to the portable reproduction unit 31 (at step S13). When the adaptor 21 has issued a reproduction request for the song to the portable reproduction unit 31, the portable reproduction unit 31 starts reproducing the song according to the request (at step S14).

Information about a cursor button operation command is received by the controller 5 and transferred to the controller 24 of the adaptor 21. The controller 24 outputs update data to the OSD controller 25 according to the operation command to move the scroll bar. When the controller 24 of the adaptor 21 has received the information about the enter button operation command, the controller 24 issues a reproduction request for the selected song to the portable reproduction unit 31. The portable reproduction unit 31 reproduces the song. The reproduction audio signal A2 is supplied to the speakers 3L and 3R through the audio selector 9 and the amplification circuit 11 of the AV unit 1.

It should be understood by those skilled in the art that various modifications, combinations, sub-combinations and alternations may occur depending on design requirements and other factors insofar as they are within the scope of the appended claims or the equivalents thereof. For example, the AV unit may have the OSD controller as the display control section. The OSD controller of the AV unit may be used instead of the OSD controller of the adaptor. In this case, the AV unit can display a list processed by the OSD controller of the AV unit, not a list processed by the OSD controller of the adaptor.

What is claimed is:

1. A content selectable reproduction system composed of a content reproduction unit having a display function of a built-in or external display device; a portable reproduction unit control apparatus connected to the content reproduction unit through first connection means; and a portable reproduction unit connected to the portable reproduction unit control apparatus through second connection means,
wherein the content reproduction unit includes:
a content reproduction section which reproduces content;
an operation section which issues an operation command; and
a first control section which inputs the operation command and controls the content reproduction section according to the operation command,
wherein the portable reproduction unit control apparatus includes:
a display control section; and
a second control section which exchanges control signals with the first control section through the first connection means,
wherein the portable reproduction unit includes:
a storage medium which stores content data files and content management data with which the content data files are managed;
a reproduction section which reproduces the reproduction content files; and
an operation section,
wherein the second control section of the portable reproduction unit control apparatus reads the content management data from the storage medium of the portable reproduction unit through the second connection means, supplies the content management data to the display control section, causes the display control section to generate a selectable content list signal according to the content management data, and supplies the selectable content list signal to the content reproduction section of the content reproduction unit through the first connection means,
wherein the first control section of the content reproduction unit supplies the selectable content list signal to the display device, and causes the display device to display a selectable content list according to the selectable content list signal,
wherein content to be reproduced is selected by a selection operation of the operation section according to the selectable content list and a selection operation signal of the operation section is supplied to the first control section,
wherein the first control section supplies the selection operation signal to the second control section through the first connection means, and
wherein the portable reproduction unit is caused to reproduce content according to the selection operation signal received by the second control section and the reproduction signal is supplied to the content reproduction section of the content reproduction unit through the first connection means.

2. The content selectable reproduction system as set forth in claim 1,
wherein the first connection means is a wired transmission path which includes a transmission path for a control signal exchanged between the first and second control sections, a transmission path for the selectable content list signal, a transmission path for content reproduced by the portable reproduction unit, and a power transmission path connected from the content reproduction unit to the portable reproduction unit control apparatus, and
wherein the content reproduction unit has a port through which the wired transmission path is connected and disconnected.

3. The content selectable reproduction system as set forth in claim 1,
wherein the content management data are data that are correlated with each of a plurality of pieces of content stored in the storage medium of the portable reproduction unit, a record position, attribute data, and a file name.

4. The content selectable reproduction system as set forth in claim 1,
wherein the content management data are play list data stored in the storage medium of the portable reproduction unit.

5. The content selectable reproduction system as set forth in claim 1,
wherein the second control section converts the received selection operation signal into a control signal with which an operation of the portable reproduction unit is controlled.

6. A content selectable reproduction method for a content selectable reproduction system composed of a content reproduction unit having a display function of a built-in or external display device; a portable reproduction unit control apparatus connected to the content reproduction unit through first connection means; and a portable reproduction unit connected to the portable reproduction unit control apparatus through second connection means, the content reproduction unit having a content reproduction section which reproduces content; an operation section which issues an operation command; and a first control section which inputs the operation command and controls the content reproduction section according to the operation command, the portable reproduction unit control apparatus having a display control section; and a second control section which exchanges control signals with the first control section through the first connection means, the portable reproduction unit having a storage medium which stores content data files and content management data with which the content data files are managed; a reproduction section which reproduces the reproduction content files; and an operation section, the content selectable reproduction method comprising the steps of:
causing the second control section of the portable reproduction unit control apparatus to read the content management data from the storage medium of the portable reproduction unit through the second connection means, the second control section to supply the content management data to the display control section, the display control section to generate a selectable content list signal according to the content management data, and the second control section to supply the selectable content list signal to the content reproduction section of the content reproduction unit through the first connection means,
causing the first control section of the content reproduction unit to supply the selectable content list signal to the display device, and the display device to display a selectable content list according to the selectable content list signal,
causing content to be reproduced to be selected by a selection operation of the operation section according to the selectable content list and a selection operation signal of the operation section to be supplied to the first control section,
causing the first control section to supply the selection operation signal to the second control section through the first connection means, and
causing the portable reproduction unit to reproduce content according to the selection operation signal received by the second control section and the reproduction signal to be supplied to the content reproduction section of the content reproduction unit through the first connection means.

7. The content selectable reproduction method as set forth in claim 6,
wherein the content management data are data that are correlated with each of a plurality of pieces of content stored in the storage medium of the portable reproduction unit, a record position, attribute data, and a file name, and
wherein the content is displayed by correlating the selectable content list and the attribute of the attribute data.

8. The content selectable reproduction method as set forth in claim 6,
wherein the content management data are play list data stored in the storage medium of the portable reproduction unit, and
wherein the selectable content list indicates a play list of the play list data.

9. The content selectable reproduction method as set forth in claim 6,
wherein the second control section converts the received selection operation signal into a control signal with which an operation of the portable reproduction unit is controlled.

10. A portable reproduction unit control apparatus, comprising:
first connection means connected to a content reproduction unit having a display function of a built-in or external display device;
second connection means connected to a portable reproduction unit;
a display control section; and
a second control section which exchanges control signals with a first control section of the content reproduction unit through the first connection means,
wherein the second control section reads the content management data from the storage medium of the portable reproduction unit through the second connection means, supplies the content management data to the display control section, causes the display control section to generate a selectable content list signal according to the content management data, and outputs the selectable content list signal to the content reproduction unit through the first connection means,
wherein the second control section receives a selection operation signal from the first control section of the content reproduction unit through the first connection means, and
wherein the portable reproduction unit is caused to reproduce content according to the received selectable operation signal and the reproduction signal is output to the content reproduction unit through the first connection means.

11. The portable reproduction unit control apparatus as set forth in claim 10,
wherein the first connection means is a wired transmission path which includes a transmission path for a control signal exchanged between the first and second control sections, a transmission path for the selectable content list signal, a transmission path for content reproduced by the portable reproduction unit, and a power transmission path connected from the content reproduction unit to the portable reproduction unit control apparatus, and
wherein connection means freely connectable to a port of the content reproduction unit is disposed at one end of the wired transmission path.

12. The portable reproduction unit control apparatus as set forth in claim 10,
wherein the second connection means causes a plurality of mechanical contacts to be contacted, and
wherein a charge power is supplied to the built-in battery of the portable reproduction unit through the second connection means.

13. The portable reproduction unit control apparatus as set forth in claim 10,
wherein the content management data are data that are correlated with each of a plurality of pieces of content stored in the storage medium of the portable reproduction unit, a record position, attribute data, and a file name.

14. The portable reproduction unit control apparatus as set forth in claim 10,
wherein the content management data are play list data stored in the storage medium of the portable reproduction unit.

15. The portable reproduction unit control apparatus as set forth in claim 10,
wherein the second control section converts the received selection operation signal into a control signal with which an operation of the portable reproduction unit is controlled.

16. The portable reproduction unit control apparatus as set forth in claim 10,
wherein the portable reproduction unit connected to the second connection means is a predetermined type.
